(19) United States
(12) Patent Application Publication
(10) Pub. No.: US 2015/0323111 A1
(43) Pub. Date: Nov. 12, 2015

(54) GROOVED AND EXTERNALLY REINFORCED PIPE END

(71) Applicants: Laurent Jean KINGSLEY, Lively (CA); Chad E. KINGSLEY, Chelmsford (CA)

(72) Inventors: Laurent Jean KINGSLEY, Lively (CA); Chad E. KINGSLEY, Chelmsford (CA)

(21) Appl. No.: 14/707,864

(22) Filed: May 8, 2015

Related U.S. Application Data
(60) Provisional application No. 61/990,312, filed on May 8, 2014.

(51) Int. Cl. F16L 21/00; F16L 9/12

(52) U.S. Cl. CPC F16L 21/00; F16L 9/12

(57) ABSTRACT

A reinforced pipe end system and method of making the system is provided. The system comprises a section of plastic pipe with at least one groove around an end portion; and a metal pipe end sleeve having an inner diameter less than an outer diameter of the plastic pipe and having at least one protrusion on an interior surface configured to mate with at least one groove when the metal pipe is pressed onto the end portion of the plastic pipe.

### TECHNICAL FIELD

The present disclosure relates to a system and method for reinforcing ends of plastic or polymer pipe, such as PVC (Polyvinyl Chloride) and HDPE (High Density Polyethylene).

### BACKGROUND

In many fields it is desirable to join plastic tubes or pipes using several different methods.

Plastic pipe will withstand high internal pressures and has many advantages over heavier and more costly steel pipe, but due to the deformation and elasticity characteristics of plastic tube under certain pressures and conditions, it has met with limited success. High pressures in a plastic pipe line can cause the plastic pipe to swage, deform and sections to come apart at adjoining pipe ends at the coupling. This has limited the use of plastic pipe in many areas and applications.

Likewise, attempts to form a groove on plastic pipe ends for use in joining two plastic pipe sections have met with little success, as high internal pressure in the plastic pipe ends has caused swaging, deformation and separation of the ends of the plastic pipe sections causing the sections to come apart at the coupling.

Another method of joining plastic pipe is the fuse weld method. (Pipe-fusion). This method is successful but very costly due to equipment purchase or rental, and labor cost.

Another method of joining plastic pipe is to glue a pre-grooved sleeve onto the ends of plastic pipe to join the pipe sections in an end to end relationship. This also has met with limited success as the high internal pressure in the plastic pipe has caused separation due to the swaging and deformation of the plastic pipe ends causing separation of the ends, causing the sections to come apart at the coupling.

Another method of joining plastic pipe is a pre-grooved roustabout fitting bolted onto the outside diameter of plastic pipe. This method has proven to be a costly alternative.

### SUMMARY

In one aspect of the present disclosure, there is provided a reinforced pipe end system comprising: a section of plastic pipe with at least one groove around an end portion; and a metal pipe end sleeve having an inner diameter less than an outer diameter of the plastic pipe and having at least one protrusion on an interior surface configured to mate with at least one groove when the metal pipe is pressed onto the end portion of the plastic pipe.

In another aspect of the present disclosure, there is provided a method of reinforcing an end of a plastic pipe, the method comprising pressing a metal pipe end sleeve onto an end of the plastic pipe, the plastic pipe having at least one groove around the end and the metal pipe end sleeve having an inner diameter less than an outer diameter of the plastic pipe and having at least one protrusion on an interior surface configured to mate with at least one groove when the metal pipe is pressed onto the end portion of the plastic pipe.

### BRIEF DESCRIPTION OF THE DRAWINGS

FIG. 1 is line drawing of the components of the reinforced pipe system in accordance with one example embodiment of the present disclosure unassembled;

FIG. 2 is a line drawing of the components of the reinforced pipe system in accordance with one example embodiment of the present disclosure assembled;

FIG. 3 is a line drawing of a two part coupling with ribs;

FIG. 4 is a line drawing of a ring gasket; and

FIG. 5 is a line drawing of two reinforced pipe ends in accordance with one example embodiment of the present disclosure joined with a coupling placed over a gasket seat.

### DETAILED DESCRIPTION

To the accomplishment of the foregoing and related ends, certain illustrative aspects are described herein in connection with the following description and the annexed drawings. These aspects are indicative of the various ways in which the principles disclosed herein can be practiced. Other advantages and novel features will become apparent from the following detailed description when considered in conjunction with the drawings.

The present disclosure provides an improved and cost effective means to reinforce the ends of a plastic or polymer pipe. In general, at least one groove is made around the exterior of an end of the plastic pipe. A metal pipe end sleeve, having an inner diameter less than that of outer diameter of the plastic pipe, has at least one protrusion on the interior designed to mate with the groove on the pipe. The sleeve is pressed onto the end of the pipe so that the protrusions of the sleeve mate with the groove on the pipe. Because the diameter of the pipe sleeve is less than that of the pipe end, the pipe compresses while the sleeve is being installed and then expands out once the sleeve is in place to apply pressure against the sleeve. The outward pressure of the pipe against the sleeve aids in keeping the sleeve in place. The sleeve provides reinforcement for the end of the pipe. In a preferred embodiment, the at least one groove comprises at least two parallel grooves and the at least one protrusion comprises at least two parallel protrusions.

The disclosed system has many advantages. The grooved and externally reinforced pipe end will be shape-retaining under pressure up to the bursting pressure of the pipe to which it has been adapted. In some embodiments, the plastic pipe has its ends accurately sized so that the plastic pipe and the sleeve have a precise friction tight fit. Using embodiments of the disclosed system and method, the plastic pipe and the metal sleeve can be joined permanently in a watertight manner. The sleeve, when pressed onto the end of a plastic pipe end, provides a safer method of joining plastic pipe in an end to end relationship than previously disclosed methods. In some embodiments, the sleeve is externally grooved, thus providing a method of externally reinforcing a plastic pipe end by creating a grooved end retaining all characteristics required to join two similar pipe sections or dissimilar pipe sections of the same size to be joined together by a coupling. When plastic pipe has been fitted with a pipe end sleeve according this disclosure, the pipe ends will withstand more robust and rough service situations. Once fitted with the pipe end sleeve, the plastic pipe end will no longer deform when under stress avoiding system failure. The newly reinforced pipe ends will withstand higher pressures, and eliminate the separation of the plastic pipe ends under normal operating conditions.

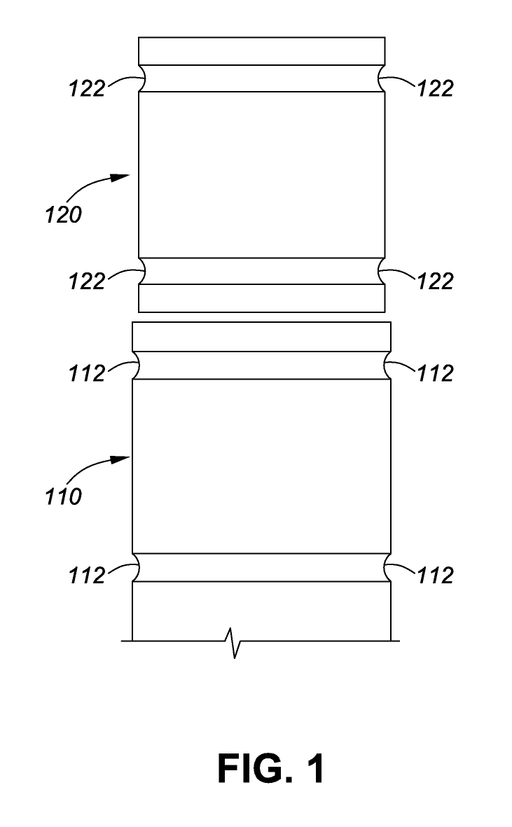

Referring to FIG. 1, the reinforced pipe end is created using the plastic pipe 110 and the metal pipe end sleeve 120. The plastic pipe, which may be of any size and gauge has pressed onto its end a metal pipe end sleeve. The inside diameter of the metal pipe end sleeve will be less than the required standard for the outside diameter of the plastic pipe. The plastic pipe 110 will have at least one groove 112. The embodiment shown in FIG. 1 has two grooves 112 that will mate with protrusions on the inside of the metal pipe end sleeve. In the embodiment shown in FIG. 1, the protrusions correspond to grooves 122 on the exterior of the pipe end sleeve 120. The diameter of the plastic pipe will be slightly larger than the inside diameter of the metal pipe end sleeve 120. In a preferred embodiment, the outside diameter of the plastic pipe is approximately 5% larger than the metal pipe end sleeve. The one or more grooves 112 in the plastic pipe end 110 can be made in a number of manners. Non-limiting examples include roll grooving that would be shape changing and cut grooving which is removal of specific amount of material.

In some embodiments, the protrusions on the interior of the metal pipe end sleeve 120 have corresponding grooves 122 on the exterior of the sleeve. In some embodiments, the metal pipe end sleeve 120 is pre grooved on its outer surface before assembly. The grooves 122 on the exterior of the pipe end sleeve 120 can be used for coupling the reinforced pipe end to another pipe end.

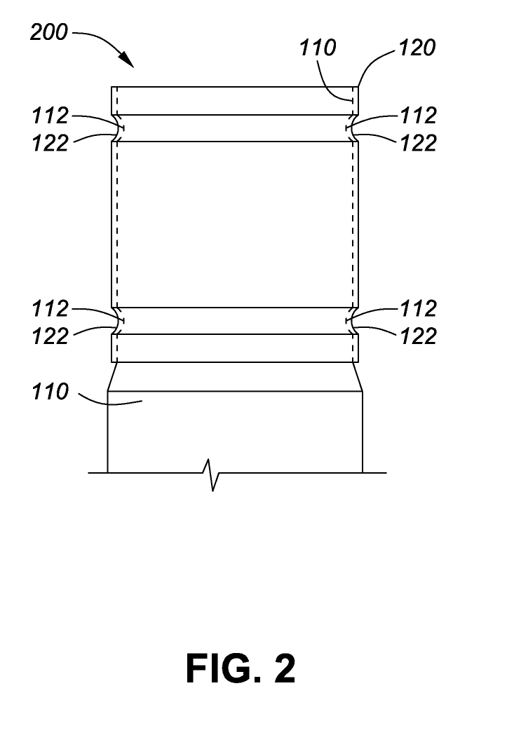

Due to the difference in diameters, the pipe end sleeve 120 will be forced onto the plastic pipe end 110 under pressure until the plastic pipe 110 and metal pipe end sleeve 120 are flush. A reinforced pipe end 200 with the pipe end sleeve 120 in place is illustrated in FIG. 2. Forcing the pipe end sleeve 120 over the plastic pipe end 110 will compress the plastic pipe slightly and the plastic pipe will then apply outward pressure against the pipe end sleeve 120, putting the plastic pipe end 110 under compression force and the metal pipe end sleeve 120 under expansion force. The opposite forces will result in a tight frictional fit and grip between the two members resisting axial movement of the metal pipe end sleeve with respect to the plastic pipe. In fact, the grip between the plastic pipe and the metal pipe end sleeve will be sufficiently strong to render it unnecessary to provide any other means of hold back to prevent axial movement of plastic pipe relative to the pipe end sleeve during normal operations.

In some embodiments, after the metal pipe end sleeve 120 has been pressed onto the plastic pipe end 110, forming rollers are used to press the existing protrusions of the metal pipe end sleeve into the existing grooves of the plastic pipe to which it has been mated. The inner roller will be flat since it is in contact with the inside diameter of the plastic pipe, and the outer roller will be convex, and will be in contact with the grooves in the metal pipe end sleeve. When necessary, this action is performed to ensure that any expansion of the grooved and metal pipe end sleeve during the pressing sequence on to the plastic pipe is brought back into contact and uniformity with the grooves in the plastic pipe ensuring a watertight and secure friction fit.

Non-limiting examples of materials from which the pipe can be made include PVC, HDPE, and Poly Ethylene.

Non-limiting examples of metals that can be used for the metal pipe include copper, steel, stainless steel, aluminum, and alloy steel.

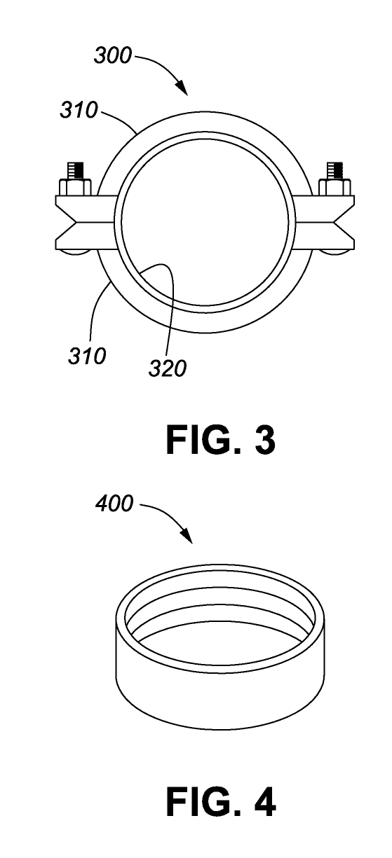

The disclosed method of reinforcement is especially effective in providing proper reinforcement of a plastic pipe to be joined in an end to end relationship by a coupling 300 such as shown in FIG. 3. Non-limiting examples of couplings that can be used are those made by Victaulic and Gruvlock.

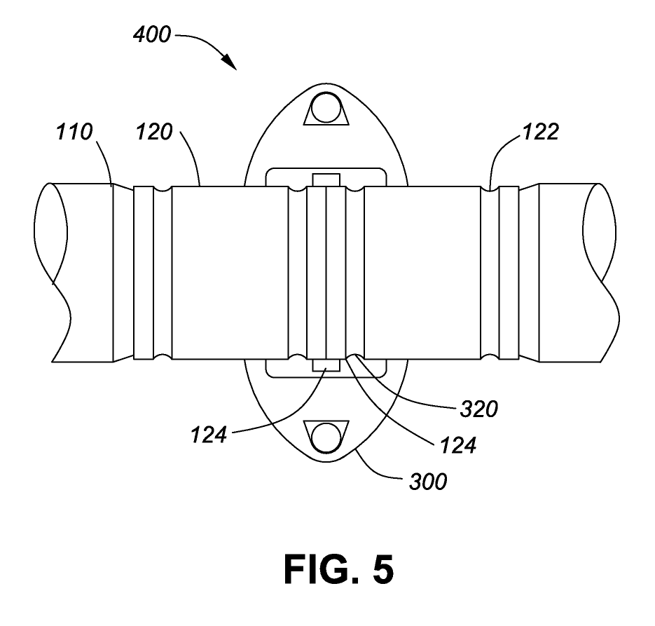

It has been observed that when the coupling mentioned above is used, that the metal pipe end sleeve prevents swaging of the plastic pipe. The coupling mentioned with reference to FIG. 3 is made of two semi-circle sections 310 that are bolted together in a clamping relation about the pipe ends. The coupling has ribs 320 that are inwardly projected and that engage the respective grooves 122 on the metal pipe end sleeve 120. FIG. 4. shows a preformed ring gasket 400 supplied with some couplings. This gasket 400 can be placed over a gasket seat 124 (shown in FIG. 5) of adjoining sleeves thus bridging the space between the sleeves. See for example FIG. 5. The gasket 400 and coupling 300 are known in the art, but are described herein because of the cooperative relationship between the coupling, gasket and the grooves in the metal pipe end sleeve, that is now part of the reinsforced pipe system 200. When the reinforced pipe end are in an end to end relationship, joined by coupling and gasket, the gasket forms a seal relative to pressure in the system, as shown in FIG. 5. The ribs 320 in the coupling 300 form a lock when introduced into the grooves 122 of the metal pipe end sleeve 120 of two joined pipes thus eliminating the possibility of swaging and or deformation of the pipe ends that would cause separation of the pipe ends. The second groove 122 in this embodiment helps reduce axial movement.

When pressure is introduced into the system, the gasket will press against the inner wall of the coupling and also press against the gasket seat on the metal pipe end sleeve thus forming a water tight seal. As the pressure in the system increases, the wall of the plastic pipe is pressed outwardly to form a tighter friction fit with the metal pipe end sleeve that is locked in thus creating a tight fit.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations.. The exemplary embodiment was chosen and described in order to best explain the principles of the present invention and its practical application, to thereby enable others skilled in the art to best utilize the present invention and various embodiments with various modifications as are suited to the particular use contemplated.

1. A reinforced pipe end system comprising:
a section of plastic pipe with at least one groove around an end portion; and
a metal pipe end sleeve having an inner diameter less than an outer diameter of the plastic pipe and having at least one protrusion on an interior surface configured to mate with the at least one groove when the metal pipe is pressed onto the end portion of the plastic pipe.

2. The reinforced pipe end of claim 1 wherein the at least one groove comprises at least two parallel grooves and the at least one protrusion comprises at least two parallel protrusions.

3. The reinforced pipe end system of claim 1 wherein the metal pipe has at least one groove on an exterior surface that corresponds to the at least one protrusion.

4. A method of reinforcing an end of a plastic pipe, the method comprising pressing a metal pipe end sleeve onto an end of the plastic pipe, the plastic pipe having at least one groove around the end and the metal pipe end sleeve having an inner diameter less than an outer diameter of the plastic pipe and having at least one protrusion on an interior surface configured to mate with at least one groove when the metal pipe is pressed onto the end portion of the plastic pipe.

5. The method of claim 4 further comprising forming the at least one groove in the plastic.

6. The method of claim 4 further comprising forming the at least one protrusion in the metal pipe end sleeve.

7. The method of claim 4 further comprising forming at least two parallel grooves in the plastic pipe.

8. The method of claim 7 further comprising forming at least two parallel protrusions on the interior surface of the pipe end sleeve the at least two parallel protrusions configured to mate with the at least two grooves in the plastic pipe.

9. The method of claim 4 wherein the pressing comprises making an end of the pipe end sleeve flush with the end of the plastic pipe.

10. The method of claim 4 further comprising using forming rollers to press the at least one protrusion into at least one groove.
